(19) United States
(12) Patent Application Publication
(10) Pub. No.: US 2012/0011037 A1
(43) Pub. Date: Jan. 12, 2012

(54) SYSTEM AND METHOD FOR CREATING A SOCIAL SERVICE DEDUCTION PLAN

(75) Inventors: Xiaopeng Tan, Mannheim (DE); Claus Steimer, Weingarten (DE); Miroslav Cina, Hanhofen (DE)

(73) Assignee: SAP AG, Walldorf (DE)

(21) Appl. No.: 12/833,302

(22) Filed: Jul. 9, 2010

(51) Int. Cl. G06Q 40/00

(52) U.S. Cl. 705/35

(57) ABSTRACT

A method and system of generating deduction plan document for issuing benefits to a recipient. The method and system may include receiving a request from a user to generate a deduction plan document; responsive to receiving the request, creating a new deduction plan document including a header and at least one data item, the header including a category data field, the at least one data item including item category and deduction amount data fields; populating the data field of the header by displaying a first graphic user interface (GUI) page through which the user enters a value to the category data field of the header; populating the data fields of the at least one data item by displaying a second GUI page through which the user enters values to the data fields of the at least one data item; responsive to the populating the deduction plan document, simulating the deduction plan document being executed in a subsequent net calculation process; and responsive to receiving a simulation result from the net calculation process, determining whether the simulation result is satisfactory; if not, displaying a third GUI page to the user for adjusting the deduction amount; and if so, displaying a third GUI page for the user to approve and activate the deduction plan document.

### REFERENCE OF RELATED APPLICATIONS

This application incorporates by reference the entire contents of U.S. Non-Provisional application Ser. No. ______ (Attorney Docket Nos. 11884/511301, 511401, 511501, 511601, and 511701) filed on even date.

### FIELD OF THE INVENTION

The present invention is generally directed to a social service payment system. In particular, the present invention is directed to a system and method for determining deductions in social service payments.

### BACKGROUND

Social service agencies may provide a wide range of social benefits to the public. For example, in U.S., the social security agency may provide social security benefits in the form of monthly payments to people who are entitled to social security benefits. Other examples of social benefits may include housing allowances, food subsidies, disability insurance payments, unemployment insurance payments, and public pension payments.

A recipient (or beneficiary) of social service may be entitled to receive benefits from multiple agencies. The benefits are commonly in the form of monetary payment. The gross benefit payment may be subject to deductions before the recipient receives a net payment. The deduction process may withhold a certain amount of money from the gross payment to redistribute the deducted amounts to fulfill other obligations. One type of deductions may be based on individualized decisions, called decision-based deductions. These decision-based deductions may include periodical fee deductions (such as, rent, cable, and utilities), claim deductions (such as, liabilities to agencies and child supports), and personal savings. Another type of deductions is based on rules, called rule-based deductions. The rule-based deductions may include income taxes (such as, federal and state income taxes) and social benefit taxes (such as, social security tax).

Because of their diverse objectives of diverse social services, different social services may be mandated by different laws and subject to different regulations. For example, certain social service benefits may not be subject to certain taxes, while others do. Further, in social service arena, deductions from gross payment may require particular care because they reduce payments to people in need. In practice, the deductions are normally carried out by social service case workers who consider many factors in determining deductions.

Conventional payroll applications such as SAP Payroll solution are not specifically designed for social services management. Although payroll applications may handle mass payments to a large number of recipients from a single income source, they are not designed to make payments to the large number of recipients from different social service programs, each having different deductions and posting payments to different accounts. Therefore, these payroll applications may not be integrated naturally with social service functionalities Furthermore, the total ownership cost (TOC) for operating a payroll application is usually high.

Therefore, there is a need for system and method that is specifically designed for making deductions from social service benefits.

### SUMMARY OF INVENTION

Embodiments of the present invention includes a method and system of generating deduction plan document for issuing benefits to a recipient. The method and system may include receiving a request from a user to generate a deduction plan document; responsive to receiving the request, creating a new deduction plan document including a header and at least one data item, the header including a category data field, the at least one data item including item category and deduction amount data fields; populating the data field of the header by displaying a first graphic user interface (GUI) page through which the user enters a value to the category data field of the header; populating the data fields of the at least one data item by displaying a second GUI page through which the user enters values to the data fields of the at least one data item; responsive to the populating the deduction plan document, simulating the deduction plan document being executed in a subsequent net calculation process; and responsive to receiving a simulation result from the net calculation process, determining whether the simulation result is satisfactory; if not, displaying a third GUI page to the user for adjusting the deduction amount; and if so, displaying a third GUI page for the user to approve and activate the deduction plan document.

### BRIEF DESCRIPTION OF THE DRAWINGS OF THE EXAMPLE EMBODIMENTS

FIG. 1 illustrates social service payment system according to an exemplary embodiment of the present invention.

FIG. 2 illustrates a system that is configured to perform the deduction decision process according an exemplary embodiment of the present invention.

FIG. 3 illustrates a deduction plan document according to an exemplary embodiment of the present invention.

FIG. 4 illustrates a detailed method to create and activate a deduction plan document according an exemplary embodiment of the present invention.

### DETAILED DESCRIPTION OF THE EXAMPLE EMBODIMENTS

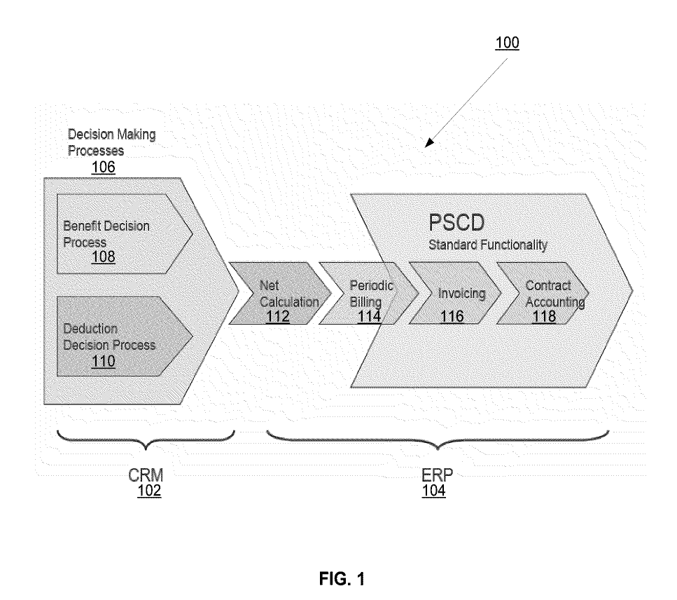

FIG. 1 illustrates social service payment system according to an exemplary embodiment of the present invention. The social service payment system 100 may include a decision making process 106 implemented on a customer relationship management (CRM) database system 102 and processes for calculating net payments and making payments implemented on an enterprise resource planning (ERP) database system 104. The decision making processes 106 further may include a benefit decision process 108 for determining a gross payment that a benefit recipient may be entitled to and a deduction decision process 110 identifying decision-based deductions and rule-based deductions that may be applicable to the benefit payments. The output of the benefit decision process may be a data object called a gross payment document, and the output of the deduction decision process may be a data object called a deduction plan document. An update of either the gross payment document or the deduction plan document may trigger a following net calculation process 112 implemented on the ERP.

The net calculation process may receive both the gross payment document and the deduction plan document for generating a data object called a net calculation document. The net calculation document may contain information for executing social service payments to the benefit recipient. The output of the net calculation in the form of a net calculation document may trigger standard payment processes such as periodic billing 114, invoicing 116, and accounting 118. Like net calculation, these standard functionalities may be implemented on the backend ERP.

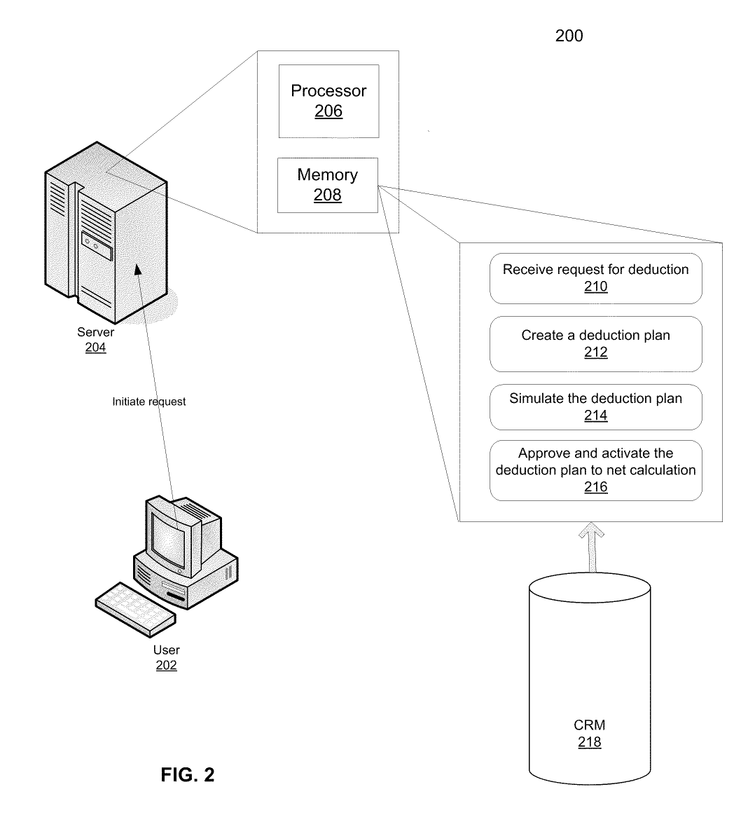

FIG. 2 illustrates a system that is configured to perform the deduction decision process 110 according an exemplary embodiment of the present invention. The system 200 may include a server 204 that may include a processor 206 and a computer-readable storage medium 208. A user 202 (such as a social case worker) may access the server through a terminal. The processor 206 may be configured with a customer relationship management (CRM) database application that may support a graphic user interface (GUI) through which deduction plan document data objects may be created.

The CRM application may be configured to support an application for creating a social service deduction plan document. The deduction plan document may be a data object that contains information relating to deductions associated with a gross payment entitled by a benefit recipient.

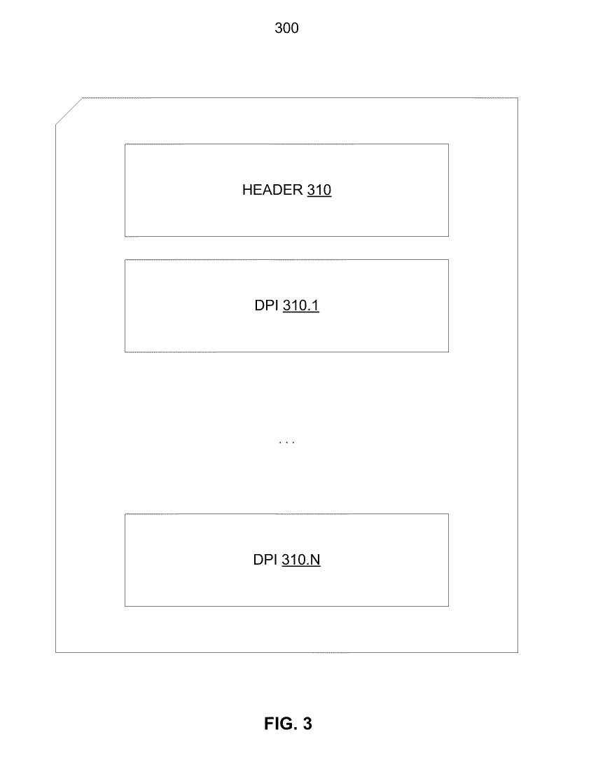

FIG. 3 illustrates a deduction plan document according to an exemplary embodiment of the present invention. As shown in FIG. 3, the deduction plan document 300 may be a data object that may include a header 310 and a list of deduction plan items 310.1 to 310.N where N is an integer greater than or equal to 1. Each deduction plan item (DPI) may be a decision-based deduction or a rule-based deduction. The decision-based deduction may be manually created by a social service case worker using a GUI implemented on a CRM. The decision-based deduction may be globally applicable to all gross payment items (GPIs). The rule-based deductions may be implemented using Business Add-Ins (BAdI) based on the rules applicable to particular GPIs. The CRM application may select which rule-based deductions to apply based on pre-defined filter values. Thus, rule-based deductions may be applied to only a subset of GPIs. Thus, each DPI may include an identifier to identify what is the deduction for. Further, each DPI may include an amount of deductions. The deduction may be either a fixed amount or a percentage of the gross payment. However, partial payment may also be supported. The DPIs may be prioritized. Thus, some DPIs may be applied first according to their priorities. The deductions are applied according to their priorities until a deductable amount reaches zero.

Referring to FIG. 2, the CRM application may include steps of receiving a request for deduction 210, creating a deduction plan document (DPD) 212, simulating the created DPD 214, and approving and activating the DPD 216.

At 210, the CRM application may receive from a user such as a social service case worker a request to create a deduction plan on behalf of a benefit recipient. The user may trigger the request by initiating execution of the application after the Benefit Decision Process 108 as shown in FIG. 1 has created or updated a gross payment document (GPD) data object representing a social service that the recipient is entitled to.

At 212, the CRM application may be used to create a data structure for a new DPD representing the deduction plan by applying decision-based deductions and rule-based deductions in accordance to the social service case worker's inputs. The CRM application may be configured with a graphical user interface (GUI) that may allow a user to categorize deduction items (such as deductions to third parties, deductions to cover previous overpayments to the recipient, deductions for services), use a search-and-select functionality of the GUI to identify sources of benefit payments to the recipient, and define deduction parameters that may include amount to be deducted, priority level of deductions, partial deductions (e.g., deduct as much as possible), and percentage deduction.

Further, at 214, in response to a request by the user and the creation of the deduction plan document, the CRM application may simulate the created deduction plan and display the simulation result to the user. The simulation may simulate deductions from gross payments over a series of payments circles. Based on the simulation results, the user may adjust deduction parameters until the user is satisfied. For example, the user such as a social service case worker may have a preset target of how much net payment to the beneficiary should be. The target may be a net monetary amount derived from government minimum living standard guidelines. Alternatively, the target may be a percentage target that represents the percentage of deductions over the gross payment. In one embodiment of the present invention, the deduction parameters may be assigned with priorities. Thus, when the user triggers an update component of the CRM application, the GUI may display the interface to update deduction parameters in an order according to the priorities of these parameters. Thereby, the user may change the deduction parameters first from those with higher priorities. For example, if the total amount of deductions is over the target, the lower priority items may be displayed first so that the user may reduce the lower priority deduction amounts. The user may iterate the process until a target deduction of the overall deduction plan is achieved. Once the target deduction is set, the evaluation of whether deductions meet the target may be calculated automatically or manually. If the calculation is automatic, the CRM application may compare the total deductions to a target amount or compare the percentage of deductions to a target percentage.

At 216, when the user are satisfied with the deduction plan, the user may approve and activate the deduction plan document, thus finalizing and transmitting the deduction plan document to a net calculation application on an ERP for executing.

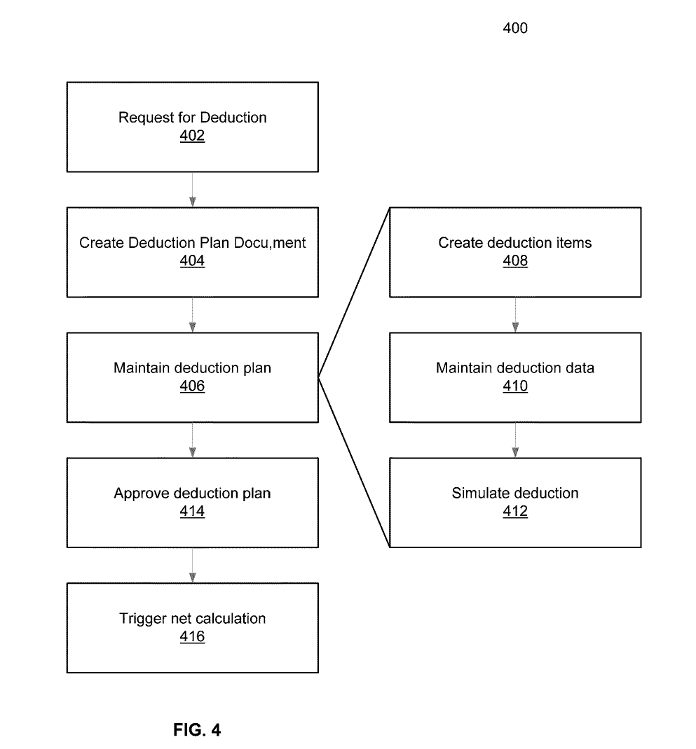

FIG. 4 illustrates a detailed method to create and activate a deduction plan document according an exemplary embodiment of the present invention. The CRM application 400 may at 402, responsive to a trigger from a user such as a social service case worker, initiate a request to create a deduction plan. The request may be initiated responsive to a new or updated entitlement in the form of gross payment documents.

At 404, responsive to the request to create a deduction plan document (DPD), the CRM application may search for if there is an existing DPD appropriate for the deductions. For example, when a gross payment item is added to an existing gross payment document (GPD) that already has a corresponding DPD, the corresponding DPD may be reused. However, when there is no appropriate DPD, a new DPD may be created at 404. To create a new DPD, the CRM may generate a data object that includes all data fields to be populated by the user. The CRM application may then display a first GUI page through which the social service case worker may populate data fields of the DPD, assign a unique case number, and maintain a header data. The GUI may include a plurality of data fields for the social service worker to fill out to create the deduction plan document. For example, the social service case worker may create a voluntary type deduction of a housing deduction plan document.

At 406, the CRM application may maintain the deduction plan by performing the following steps. At 408, the CRM application may display a second GUI page to create deduction plan items. The second GUI page may include command path ways for the user to select parameters for the DPI including item identification, item category, start and end dates, deduct-to-party, deduct-from-party, deduction amount, description, and currency. The command path ways may include commonly used means to enter data, such as a drop down box list, a form, a calendar, or select buttons. A DPI created may include data fields for these DPI parameters.

At 410, the CRM application may display a third GUI page for adding detailed information about the DPI parameters. The CRM application may maintain header information, select payment from which the deduction is made, assign “deduct-to” party, show payment details of the deduct-to-party's payment, and maintain deduction amount and percentage. All these operations on DPIs may be carried out in the context of the corresponding GPIs. For example, if the corresponding GPIs are within a group the members of which meet certain criteria, the DPIs may be specified within these criteria. The output of step 410 may be a deduction plan document data object with all parameters specified.

At 412, in response to the creation of the fully specified deduction plan document, the CRM application may display a forth GUI page to run a simulation of the created deduction plan. To run the simulation, the CRM application may trigger a net calculation application in a backend ERP to simulate the newly created deduction item and other deduction items within the deduction plan document. The net calculation application may calculation net payments to a benefit recipient based on a gross payment document and the deduction plan document. The result of the net calculation may be compared to a target automatically. Alternatively, the result of net calculation may be presented to the social service case worker for her to decide. The social service case worker may adjust deduction plan items until it reaches a satisfactory result. As discussed above, the simulation may be an iterative process during which adjustable deduction parameters may be presented to the social service case worker for adjustment.

At 414, responsive to receiving a satisfactory simulation result, the CRM may execute an approval module to approve and active the deduction plan document. Alternatively, the social service case worker may manually approve the plan. The CRM application may display a fifth GUI page through which the social service case worker may approve the deduction plan document and activate the deduction plan document data object.

Finally, at 416, the CRM application may transmit the activated deduction plan document to a net calculation application on an ERP database application to launch the net calculation application. Alternatively, the DPD data object may be saved, and the CRM application may be navigated to a follow-up DPD data object.

In one embodiment of the present invention, the CRM application may further include a change plan optional step at which the deduction plan may be changed to a new version, put on hold for resuming later, and modified by adding and canceling deduction items. The new deduction plan may be made activated.

The various computer systems described herein may each include a storage component for storing machine-readable instructions for performing the various processes as described and illustrated. The storage component may be any type of machine readable medium (i.e., one capable of being read by a machine) such as hard drive memory, flash memory, floppy disk memory, optically-encoded memory (e.g., a compact disk, DVD-ROM, DVD±R, CD-ROM, CD±R, holographic disk), a thermomechanical memory (e.g., scanning-probe-based data-storage), or any type of machine readable (computer readable) storing medium. Each computer system may also include addressable memory (e.g., random access memory, cache memory) to store data and/or sets of instructions that may be included within, or be generated by, the machine-readable instructions when they are executed by a processor on the respective platform. The methods and systems described herein may also be implemented as machine-readable instructions stored on or embodied in any of the above-described storage mechanisms.

Although the present invention has been described with reference to particular examples and embodiments, it is understood that the present invention is not limited to those examples and embodiments. Further, those embodiments may be used in various combinations with and without each other. The present invention as claimed therefore includes variations from the specific examples and embodiments described herein, as will be apparent to one of skill in the art.

What is claimed is:

1. A computer-implemented method of generating deduction plan document for issuing benefits to a recipient, comprising:
receiving, by a processor, a request from a user to generate a deduction plan document;
responsive to receiving the request, creating, by the processor, a new deduction plan document including a header and at least one data item, the header including a category data field, the at least one data item including item category and deduction amount data fields;
populating the data field of the header by the processor displaying a first graphic user interface (GUI) page through which the user enters a value to the category data field of the header;
populating the data fields of the at least one data item by the processor displaying a second GUI page through which the user enters values to the data fields of the at least one data item;
responsive to the populating the deduction plan document, simulating, by the processor, the deduction plan document being executed in a subsequent net calculation process;
responsive to receiving a simulation result from the net calculation process, determining, by the processor, whether the simulation result is satisfactory; and
if not, displaying, by the processor, a third GUI page to the user for adjusting the deduction amount;
if so, displaying a third GUI page for the user to approve and activate the deduction plan document.

2. The method of claim 1, further comprising:
responsive to receiving the user request, determining whether there is an existing deduction document plan that meets the request;
if so, loading the existing deduction document plan for an updating;
if not, creating the new deduction document plan.

3. The method of claim 1, wherein the at least one data items further includes data fields at least one of start date, end date, deduct-to, and deduct-from, description, and currency.

4. The method of claim 1, wherein the deduction amount is one of an absolute amount and a percentage.

5. The method of claim 1, wherein the deduction amount is a partial deduction that fulfills only part of a requested deduction.

6. The method of claim 1, wherein the simulation result is compared against a preset target value to determine whether the simulation result is satisfactory.

7. The method of claim 6, wherein the simulation result is a net payment and the target is a minimum living standard.

8. The method of claim 6, wherein the simulation result is a percentage of the total deduction over a gross payment, and the target is a percentage value.

9. The method of claim 6, wherein each of the at least one deduction item has a priority level.

10. The method of claim 9, wherein the displaying the third GUI pages of the at least one deduction item is an order according to their priority level.

11. A system for generating deduction plan document for issuing benefits to a recipient, comprising:
a processor;
a memory coupled to the processor, the processor configured to:
receive a request from a user to generate a deduction plan document;
responsive to receiving the request, create a new deduction plan document including a header and at least one data item, the header including a category data field, the at least one data item including item category and deduction amount data fields;
populate the data field of the header by the processor by displaying a first graphic user interface (GUI) page through which the user enters a value to the category data field of the header;
populate the data fields of the at least one data item by displaying a second GUI page through which the user enters values to the data fields of the at least one data item;
responsive to populating the deduction plan document, simulate the deduction plan document being executed in a subsequent net calculation process;
responsive to receiving a simulation result from the net calculation process, determine whether the simulation result is satisfactory;
if not, display a third GUI page to the user for adjusting the deduction amount;
if so, display a third GUI page for the user to approve and activate the deduction plan document.

12. The system of claim 11, wherein the processor further configured to:
responsive to receiving the user request, determine whether there is an existing deduction document plan that meets the request;
if so, load the existing deduction document plan for an updating;
if not, create the new deduction document plan.

13. The system of claim 11, wherein the at least one data items further includes data fields at least one of start date, end date, deduct-to, and deduct-from, description, and currency.

14. The system of claim 11, wherein the deduction amount is one of an absolute amount and a percentage.

15. The system of claim 11, wherein the deduction amount is a partial deduction that fulfills only part of a requested deduction.

16. The system of claim 11, wherein the simulation result is compared against a preset target value to determine whether the simulation result is satisfactory.

17. The system of claim 16, wherein the simulation result is a net payment and the target is a minimum living standard.

18. The system of claim 16, wherein the simulation result is a percentage of the total deduction over a gross payment, and the target is a percentage value.

19. The system of claim 16, wherein each of the at least one deduction item has a priority level.

20. The system of claim 19, wherein the displaying the third GUI pages of the at least one deduction item is in an order according to their priority level.

21. A computer-readable storage medium stored thereon executable code that when executed performs a method, the method comprising:
receiving, by a processor, a request from a user to generate a deduction plan document;
responsive to receiving the request, creating, by the processor, a new deduction plan document including a header and at least one data item, the header including a category data field, the at least one data item including item category and deduction amount data fields;
populating the data field of the header by the processor displaying a first graphic user interface (GUI) page through which the user enters a value to the category data field of the header;
populating the data fields of the at least one data item by the processor displaying a second GUI page through which the user enters values to the data fields of the at least one data item;
responsive to populating the deduction plan document, simulating, by the processor, the deduction plan document being executed in a subsequent net calculation process;
responsive to receiving a simulation result from the net calculation process, determining, by the processor, whether the simulation result is satisfactory;
if not, displaying, by the processor, a third GUI page to the user for adjusting the deduction amount;
if so, displaying a third GUI page for the user to approve and activate the deduction plan document.
